(19) United States
(12) Patent Application Publication
(10) Pub. No.: US 2021/0132329 A1
(43) Pub. Date: May 6, 2021

(54) AUTO FOCUSING APPARATUS

(71) Applicant: MICRO ACTUATOR CO., LTD., Gyeonggi-do (KR)

(72) Inventors: Dae Soon LIM, Gyeonggi-do (KR); Hak Ku YOON, Gyeonggi-do (KR); Myung Won CHOI, Gyeonggi-do (KR); Dong Sung LEE, Gyeonggi-do (KR)

(73) Assignee: MICRO ACTUATOR CO., LTD., Gyeonggi-do (KR)

(21) Appl. No.: 17/255,774

(22) PCT Filed: Jun. 18, 2019
(86) PCT No.: PCT/KR2019/007307

§ 371 Date: Dec. 23, 2020

(30) Foreign Application Priority Data
Jul. 12, 2018 (KR) 10-2018-0081125

(51) Int. Cl. G02B 7/09

(52) U.S. Cl. CPC G02B 7/09

(57) ABSTRACT

An auto focusing apparatus according to the present invention comprises: a base having an accommodation groove; a lens carrier provided in the accommodation groove of the base; a magnet provided on one surface of the lens carrier; a coil provided to the base so as to face the magnet; a main ball accommodation part formed in a corner of one side of the inner surface of the base facing the magnet on the lens carrier; a sub-ball accommodation part which is provided on the inner surface of the base, on which the main ball accommodation part is not formed, and which supports the other surface of the lens carrier, on which the magnet is not provided; a guide protrusion which is provided on the lens carrier at one side of the magnet and which protrudes toward the main ball accommodation part; and a plurality of balls provided between the main ball accommodation part and the guide protrusion and between the sub-ball accommodation part and the other surface of the lens carrier, wherein one ball is provided between the sub-ball accommodation part and the other surface of the lens carrier.

### TECHNICAL FIELD

The disclosure relates to an auto focusing apparatus that is capable of photographing a clear image by adjusting a focal distance.

### DESCRIPTION OF THE RELATED ART

Recently, a lens assembly of a camera provided in a portable apparatus such as a mobile communication terminal can photograph an image of high pixels, e.g., an image of 13,000,000 pixels like a general digital camera, and can thus implement a high resolution. As described above, as a lens assembly of a camera mounted on a mobile communication terminal came to have a high performance, not only an optical zoom function but also various functions like an automatic focus adjusting function or an image stabilizing function are being applied.

In particular, through an automatic focus adjusting function, a clean and clear image can be photographed automatically according to a distance between a camera and a subject.

Meanwhile, a lens assembly of a camera by a conventional technology having an automatic focus adjusting function has a problem that, when a lens carrier moves in an optical axis direction for automatic focus adjustment, a phenomenon that the lens carrier cannot move precisely may occur due to a phenomenon that the lens carrier is tilted by a magnetic force, and the like.

Also, a lens assembly of a camera by a conventional technology has a structure of guiding movement of a lens carrier by using a plurality of balls, but there is a problem that a phenomenon that the lens carrier is broken by the balls during a fall may occur.

### DETAILED DESCRIPTION OF THE INVENTION

### Technical Problem

The disclosure was devised in consideration of the aforementioned problems, and relates to an auto focusing apparatus that can improve reliability and durability of a movement of a lens carrier so that a clear image can be photographed.

### Technical Solution

An auto focusing apparatus according to an aspect of the disclosure includes a base having an accommodation groove, a lens carrier provided in the accommodation groove of the base, a magnet provided on one surface of the lens carrier, a coil provided to the base so as to face the magnet, a main ball accommodation part formed in a corner of one side of the inner surface of the base facing the magnet on the lens carrier, a sub-ball accommodation part which is provided on the inner surface of the base, on which the main ball accommodation part is not formed, and which supports the other surface of the lens carrier, on which the magnet is not provided, a guide protrusion which is provided on the lens carrier at one side of the magnet and which protrudes toward the main bail accommodation part, and a plurality of balls provided between the main ball accommodation part and the guide protrusion and between the sub-ball accommodation part and the other surface of the lens carrier, wherein one ball may be provided between the sub-ball accommodation part and the other surface of the lens carrier.

Here, the main ball accommodation part may be formed as a groove having a rectangular cross section, and the bottom surface of the main ball accommodation part may be formed to be tilted with respect to one surface of the base on which the coil is provided.

Also, the front end of the guide protrusion may be formed in a round shape, and the plurality of balls may be provided to the main ball accommodation part in two rows in an optical axis direction centered around the front end of the guide protrusion.

In addition, a guide pin may be provided on the part of the guide protrusion contacted by the plurality of balls.

Further, the front end of the guide protrusion may be formed as an inversed L-shaped groove, and the plurality of balls may be provided between the front end of the guide protrusion and the main ball accommodation part in a row.

Also, guide pins may be provided in a corner of the inversed L-shaped groove of the front end of the guide protrusion so as to have a point contact with each of the plurality of balls.

In addition, the sub-ball accommodation part may be formed such that the balls support the center of the lens carrier in the longitudinal direction of the lens carrier.

Further, the balls accommodated in the main ball accommodation part may support the lens carrier in an X-Y direction, and the balls accommodated in the sub-ball accommodation part may support the lens carrier in a Y direction.

### Effect of the Invention

An auto focusing apparatus according to an embodiment of the disclosure having a configuration as above has a configuration wherein the guide protrusion of the lens carrier is supported by a plurality of balls accommodated in the main ball accommodation part of the base, and the surface on which the guide protrusion is provided and the other surface of the lens carrier are supported by one ball accommodated in the sub-ball accommodation part. Thus, the lens carrier can be driven according to a predetermined route without shaking along an optical axis direction. Accordingly, the auto focusing apparatus according to an embodiment of the disclosure can perform a precise and stable auto focusing function.

Also, in the case of the auto focusing apparatus according to an embodiment of the disclosure, a guide pin having big strength is arranged on the part supported by the plurality of balls accommodated in the main ball accommodation part. Accordingly, the number of balls supporting the lens carrier can be reduced, and reliability and durability can be improved.

### BRIEF DESCRIPTION OF DRAWINGS

FIG. 1 is a perspective view illustrating an auto focusing apparatus according to an embodiment of the disclosure;

FIG. 2 is an exploded perspective view of the auto focusing apparatus in FIG. 1;

FIG. 3 is a plan view illustrating the auto focusing apparatus in FIG. 1 wherein the cover has been removed;

FIG. 4 is a partially cut-away perspective view illustrating a plurality of balls accommodated in the main ball accommodation part of the auto focusing apparatus in FIG. 3;

FIG. 5 is a side view of the auto focusing apparatus in FIG. 3;

FIG. 6 is a plan view illustrating a modified embodiment of the auto focusing apparatus according to an embodiment of the disclosure;

FIG. 7 is a perspective view illustrating an auto focusing apparatus according to another embodiment of the disclosure;

FIG. 8 is an exploded perspective view of the auto focusing apparatus in FIG. 7;

FIG. 9 is a plan view illustrating the auto focusing apparatus in FIG. 7 wherein the cover has been removed;

FIG. 10 is a plan view illustrating a modified embodiment of the auto focusing apparatus according to another embodiment of the disclosure; and

FIG. 11 is a plan view illustrating another modified embodiment of the auto focusing apparatus according to another embodiment of the disclosure.

### BEST MODE FOR IMPLEMENTING THE INVENTION

Hereinafter, embodiments of an auto focusing apparatus according to the disclosure will be described in detail with reference to the accompanying drawings.

As terms used in this specification and the claims, general terms were selected, in consideration of the functions in the various embodiments of the disclosure. However, the terms may vary depending on the intention of those skilled in the art, legal or technical interpretation or emergence of new technologies. Also, there are some terms that were arbitrarily designated by the applicant, and the meaning of such terms may be interpreted as defined in this specification. Meanwhile, terms that are not specifically defined in the disclosure may be interpreted based on the overall content of this specification and common technical knowledge in the pertinent art.

Also, the same reference numerals or symbols described in each drawing accompanying this specification refer to components or elements substantially performing the same functions. For the convenience of explanation and understanding, the components or elements will be described by using the same reference numerals or symbols in different embodiments. That is, even if all components having the same reference numerals are illustrated in a plurality of drawings, the plurality of drawings do not mean one embodiment.

In addition, in this specification, singular expressions include plural expressions, unless defined obviously differently in the context. Further, in the disclosure, terms such as “include” and “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

Also, in the embodiments of the disclosure, the description that a part is “connected to” another part includes not only direct connection, but also indirect connection through still another medium. Further, the description that a part “includes” an element can be interpreted to mean that other elements may additionally be included, but not that other elements are excluded, unless there is any specific description meaning the contrary.

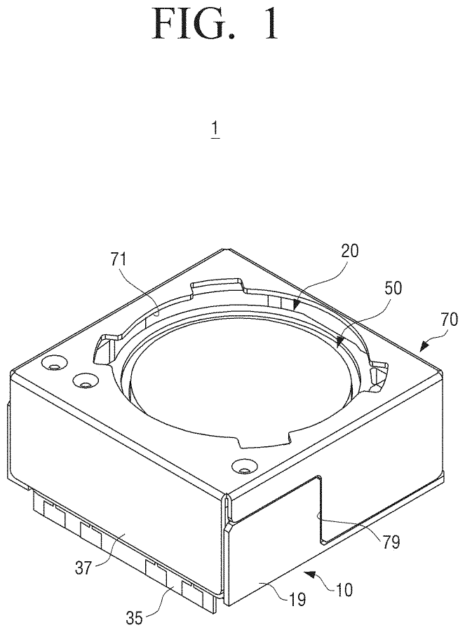

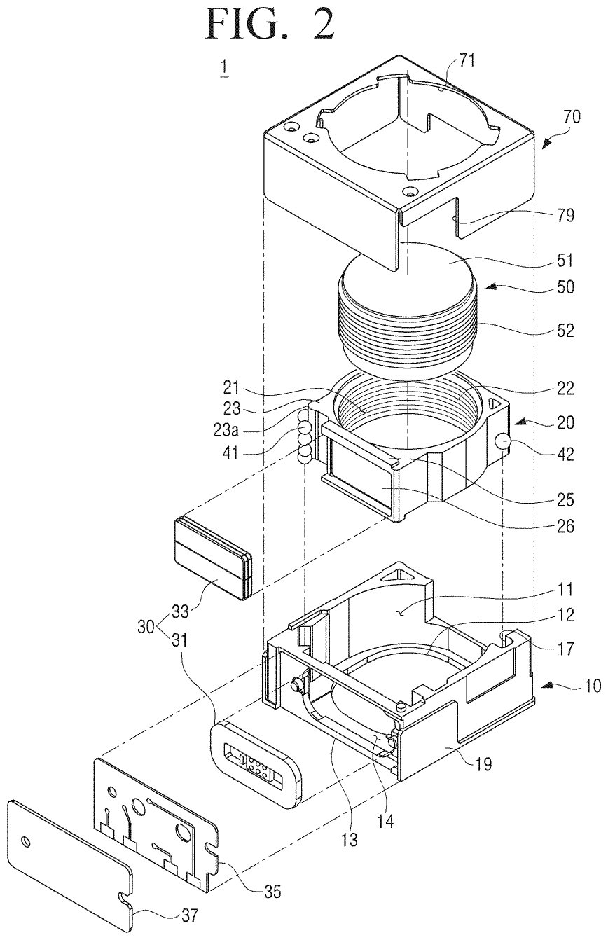

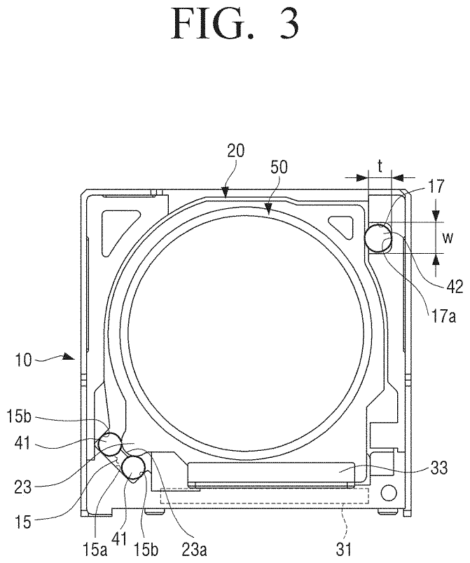

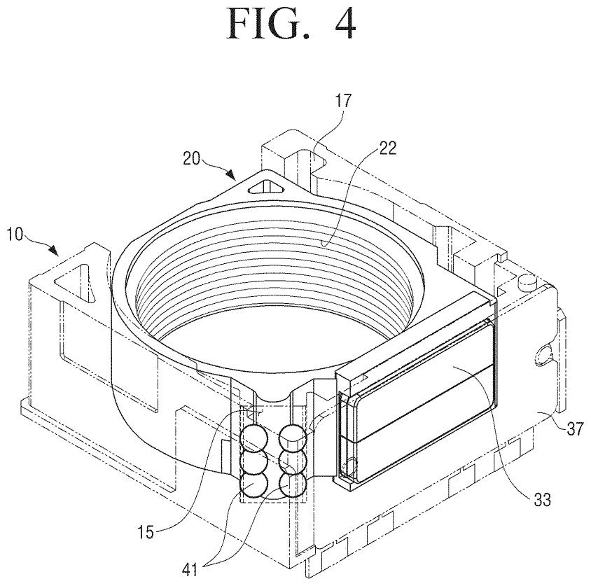

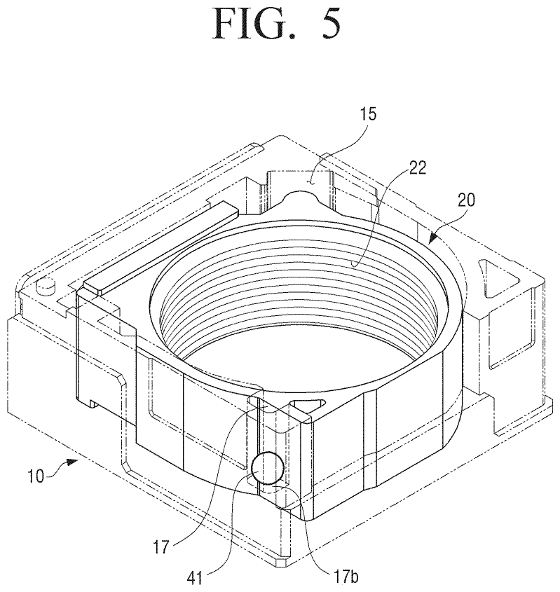

FIG. 1 is a perspective view illustrating an auto focusing apparatus according to an embodiment of the disclosure. FIG. 2 is an exploded perspective view of the auto focusing apparatus in FIG. 1. FIG. 3 is a plan view illustrating the auto focusing apparatus in FIG. 1 wherein the cover has been removed. FIG. 4 is a partially cut-away perspective view illustrating a plurality of balls accommodated in the main ball accommodation part of the auto focusing apparatus in FIG. 3. FIG. 5 is a side view of the auto focusing apparatus in FIG. 3. For reference, FIG. 4 and. FIG. 5 illustrate a lens carrier from which a lens barrel has been excluded.

Referring to FIG. 1 to FIG. 5, the auto focusing apparatus 1 according to an embodiment of the disclosure may include a base 10, a lens carrier 20, a driving part 30, and a plurality of balls 41, 42.

In the center of the base 10, an accommodating groove 11 accommodating the lens carrier 20 is provided. On the bottom of the accommodating groove 11, i.e., on the lower surface of the base 10, a light passing hole 12 though which external lights pass is formed. The diameter of the light passing hole 12 is formed to be smaller than the diameter of the lens carrier 20. Accordingly, when the lens carrier 20 is inserted into the accommodating groove 11 of the base 10, the lens carrier 20 does not fall into the light passing hole 12. Also, the accommodating groove 11 is formed in a shape corresponding to the outer side surface of the lens carrier 20.

On one side surface of the base 10, a coil mounting part 13 on which a coil 31 is installed is provided. On the coil mounting part 13, an opening 14 is formed such that a magnet 33 installed on the lens carrier 20 can be exposed.

On the inner surface of the base 10, i.e., on the inner side surface of the accommodating groove 11, a ball accommodating part wherein the plurality of balls 41, 42 are accommodated is provided. The ball accommodating part is provided to be connected with the accommodating groove 11. Also, the ball accommodating part may include a main ball accommodating part 15 provided on one side of the coil. 31 (in other words, one side of the magnet 33) and a sub ball accommodating part 17 formed on a surface different from the inner surface of the front surface of the base 10 on which the coil 31 is installed on the other side of the coil 31.

Between the main ball accommodating part 15 and the lens carrier 20, the plurality of balls 41 are accommodated, and support the sliding movement of the lens carrier 20 in an optical axis direction. Also, between the sub ball accommodating part 17 and the lens carrier 20, one ball 42 is accommodated, and supports the sliding movement of the lens carrier 20 in an optical axis direction. Here, an optical axis direction refers to a direction that is perpendicular to the lower surface of the base 10 on which the light passing hole 12 is formed.

Referring to FIG. 3, the main ball accommodating part 15 is formed in a corner of one side of the inner surface of the base 10 facing the magnet 33 of the lens carrier 20. The main ball accommodating part 15 is formed as a groove having an approximately rectangular cross section. Here, the bottom surface 15a of the main ball accommodating part 15 is formed to be tilted with respect to one surface of the base 10 on which the coil 31 is installed, i.e., the inner surface of the front surface of the base 10 on which a coil seating part 13 is provided. Accordingly, the main ball accommodating part 15 is formed on another surface which is not in parallel to the inner surface of the front surface of the base 10. In the case of this embodiment, the bottom surface 15a of the main ball accommodating part 15 is formed to constitute an obtuse angle with the inner surface of the front surface of the base 10.

As described above, if the main ball accommodating part 15 is formed on a surface that is tilted with respect to the inner surface of the front surface of the base 10, in case the sizes of the base 10 and the coil 31 are maintained to be the same, the balls 41 accommodated in the main ball accommodating part 15 become farther distanced from the coil 31 than a case of forming the main ball accommodating part 15 on a surface that is in parallel to the front surface of the base 10. Also, if the main ball accommodating part 15 is formed to be tilted, a tilting phenomenon that occurs in the lens carrier 20 by an electromagnetic force between the magnet 33 and the coil 31 can be reduced.

The sub ball accommodating part 17 is provided inside the base 10 such that it can support another surface of the lens carrier 20, i.e., a surface that is different from one surface of the lens carrier 20 on which the magnet 33 is installed or a surface of the lens carrier 20 supported by the plurality of balls 41 accommodated in the main ball accommodating part 15. In the case of the embodiment illustrated in FIG. 3, the sub ball accommodating part 17 is provided on the inner surface of the base 10 that constitutes an approximately right angle with the inner surface of the surface on which the coil mounting part 13 is installed, in a place that is far from the coil 31. Specifically, the sub ball accommodating part 17 is provided in an approximately diagonal direction with respect to the main ball accommodating part 15. Accordingly, the ball 42 accommodated in the sub bail accommodating part 17 may support the end portion of the lens carrier 20.

Also, the sub bail accommodating part 17 is formed such that the one bail 42 can be located in the center of the lens carrier 20 in a longitudinal direction of the lens carrier 20. That is, the lower end 17b of the sub ball accommodating part 17 may be located in an approximate center in an approximately longitudinal direction of the base 10. Accordingly, the one ball 42 accommodated in the sub ball accommodating part 17 can support the lens carrier 20 stably.

The width w of the sub ball accommodating part 17 is formed to be bigger than the diameter of the ball 42, and the depth t of the sub ball accommodating part 17 is formed to be smaller than the diameter of the ball 42. Accordingly, the ball 42 accommodated in the sub ball accommodating part 17 may support the lens carrier 20 through a two point contact. That is, as illustrated in FIG. 3, the ball 42 accommodated in the sub ball accommodating part 17 contacts one surface of the lens carrier 20 and the bottom surface 17a of the sub ball accommodating part 17 and supports the lens carrier 20.

As the plurality of balls 41 accommodated in the main ball accommodating part 15 and the ball 42 accommodated in the sub ball accommodating part 17 constituted as described above respectively support different surfaces of the lens carrier 20, the movement of the lens carrier 20 in an optical axis direction can be supported stably.

The coil 31 is installed on the coil mounting part 13 provided on the outer side surface of the base 10, and one surface of the coil 31 faces the magnet 33 installed on the lens carrier 20. The coil 31 is formed by winding a wire, and is formed in an approximate track shape. The coil 31 forms the driving part 30 generating a force moving the lens carrier 20 together with the magnet 33 installed on the lens carrier 20.

On one surface of the substrate 35, a terminal part (not shown) that is installed on the outer side of the coil 31, and applies power to the coil 31 may be provided. Through this, the coil 31 may receive power from the substrate 35 and generate a driving power moving the lens carrier 20 by an interaction with the magnet 33. As an example, the substrate 35 may be a flexible printed circuit board (FPCB), and the coil 31 may be electronically connected with the substrate 35 and fixed at the same time.

The yoke 37 may be arranged on the outer side of the coil 31, and fixed to the outer surface of the base 10. The yoke 37 may be formed to have a larger area than the area of the coil 31, and through this, the strength of a magnetic field formed between the coil 31 and the magnet 33 may be increased, and at the same time, the magnetic field may be extended.

Meanwhile, on the substrate 35, a hall sensor (not shown) may be mounted. The hall sensor may be spaced apart from the outer circumferential surface of the magnet 33 in an adjacent distance and may be electronically connected with the substrate 35. The controller (not shown) of the auto focusing apparatus 1 may sense the location of the lens carrier 20 (or the location of the lens) through the hall sensor, and may calculate a direction and a moving distance by which the lens carrier 20 is to be moved in an auto focusing operation based on the location information of the lens sensed through the hall sensor.

However, the installed location of the hall sensor is not limited to the substrate 35. The hall sensor may be arranged in parallel with the magnet 33 installed on the lens carrier 20 side, and the hall sensor and the magnet 33 may face each other, and the hall sensor may be installed in various locations such as the upper part of the coil 31, the side part of the coil 31, the lower part of the coil 31, etc.

The lens carrier 20 may include a hollow 21 corresponding to the light passing hole 12 formed on the base 10, and its outer surface may be formed in a shape corresponding to the accommodating groove 11 formed on the base 10. On the outer surface of the lens carrier 20, a guide protrusion 23 is provided. The guide protrusion 23 may protrude in a location corresponding to the main ball accommodating part 15 of the base 10, and the front end 23a of the guide protrusion 23 may be located in the inlet of the main ball accommodating part 15 of the base 10.

Referring to FIG. 3 and FIG. 4, the guide protrusion 23 may be located to be eccentric to one side from the center of one surface of the lens carrier 20. The front end 23a of the guide protrusion 23 is formed in a round shape. Accordingly, if the front end 23a of the guide protrusion 23 is located in the inlet of the main ball accommodating part 15, the plurality of balls 41 accommodated in the main ball accommodating part 15 may be spaced apart from one another centered around the front end 23a of the guide protrusion 23, and arranged in two rows. The plurality of balls 41 installed in two rows in the main ball accommodating part 15 constitute a laminated structure in an optical axis direction. In the case of the embodiment illustrated in FIG. 4, a configuration wherein three balls 41 are laminated in an optical axis direction in one row is formed.

Here, the plurality of balls 41 accommodated in the main ball accommodating part 15 support the lens carrier 20 through a three point contact. Specifically, one ball 41 contacts the front end 23a of the guide protrusion 23 of the lens carrier 20 and the bottom surface 15a and the side surface 15b of the main ball accommodating part 15, and thus the ball 41 may support the lens carrier 20 through a three point contact.

If the plurality of balls 41 inserted into the main ball accommodating part 15 contact the front end 23a of the guide protrusion 23 of the lens carrier 20 and support one side of the lens carrier 20 in an Y-Y direction, the other side of the lens carrier 20 may be tilted in a Y direction due to the influence of an electromagnetic force between the magnet 33 and the coil 31. Here, the ball 42 inserted into the sub ball accommodating part 17 may support the other surface of the lens carrier 20 just by a two point contact, and may thereby minimize tilting of the lens carrier 20.

On one surface of the lens carrier 20, a magnet mounting part 25 on which the magnet 33 is installed may be provided. For example, the magnet mounting part 25 may be located on a surface different from the guide protrusion 23, and may protrude from one surface of the lens carrier 20. Accordingly, the guide protrusion 23 is formed to protrude from a surface tilted with respect to one surface of the lens carrier 20 on which the magnet mounting part 25 is installed. Also, on the magnet mounting part 25, an installing groove 26 on which the magnet 33 is installed may be formed.

The magnet 33 may magnetize a plurality of poles such that polarity is intersected. For example, in the magnet 33, an N pole and an S pole may respectively be magnetized on the inner/outer circumferential surfaces on one side and the other side. That is, on one side of the surface of the magnet 33 facing the coil 31, an N pole may be magnetized, and an S pole may be magnetized on the other side, respectively, and on the opposing surface, an S pole may be magnetized on one side, and an N pole may be magnetized on the other side, respectively.

As described above, by magnetizing an N pole and an S pole as four poles respectively on the inner/outer circumferential surfaces on both sides of the magnet 33, a magnetic field section wherein the strength of the magnetic force sensed by the hall sensor increases or decreases uniformly may be formed.

On the lens carrier 20, a lens barrel 50 is provided. The lens barrel 50 may include at least one lens.

The lens barrel 50 may be coupled to the hollow 21 of the lens carrier 20. For example, on the inner circumferential surface of the hollow 21 of the lens carrier 20, a female screw 22 may be formed, and on the outer circumferential surface of the lens barrel 50, a male screw 52 may be formed, and the lens barrel 50 may be screw-coupled to the lens carrier 20. Accordingly, it is possible to separate the lens barrel 50 from the lens carrier 20 even after coupling the lens barrel 50 to the lens carrier 20.

Accordingly, in case a replacement is necessary due to a defect of the lens barrel 50, only the lens barrel 50 may be separated from the lens carrier 20 and replaced with a new lens barrel 50. As a result of this, in case the lens provided on the lens barrel 50 is defective, a problem of having to discard the entire auto focusing apparatus 1 does not occur.

Meanwhile, a method of coupling the lens barrel 50 to the lens carrier 20 is not limited to screw-fastening, and it may be a detachable method such as a press coupling, a bonding coupling, or a combination thereof.

In the auto focusing apparatus 1 according to an embodiment of the disclosure having a configuration as described above, by the configuration wherein the guide protrusion 23 of the lens carrier 20 is supported by the plurality of balls 41 accommodated in the main ball accommodating part 15 of the base 10, and one surface of the lens carrier 20 different from the surface on which the guide protrusion 23 is installed is supported by one ball 42 accommodated in the sub ball accommodating part 17 of the base 10, the lens carrier 20 may be driven according to a predetermined route without shaking along an optical axis direction. Accordingly, the lens carrier 20 can perform movements in forward and backward directions precisely and stably in spite of manufacture tolerances of components constituting the auto focusing apparatus 1.

Also, the cover 70 may be coupled to the base 10 so as to cover the side surfaces and the top surface of the base 10. On the top surface of the cover 70, a light passing hole 71 through which external lights pass is provided. The cover 70 is provided so as to shield an external electromagnetic influence. For example, for the cover 70, materials such as steel, stainless, nickel-silver, etc. which are advantageous in shielding electromagnetic waves may be used. The cover 70 may be formed to correspond to the shape and the size of the base 10.

For preventing mis-coupling of the cover 70 to the base 10, a coupling part may be provided on the cover 70 and the base 10. For example, on one side surface of the base 10, a coupling surface 19 protruding to a specific height may be provided, and on one side surface of the cover 70, a coupling groove 79 corresponding to the coupling surface 19 of the base 10 may be provided. Accordingly, if the coupling groove 79 of the cover 70 is inserted into the coupling surface 19 of the base 10, the cover 70 may be coupled to the base 10 easily and precisely.

Hereinafter, an operation of the auto focusing apparatus 1 according to an embodiment of the disclosure having a configuration as above will be described with reference to FIG. 1 to FIG. 5.

For reference, hereinafter, ‘a forward direction’ of the lens carrier 20 refers to a direction of the movement of the lens carrier 20 wherein a gap between the lower surface of the base 10 and the lower surface of the lens carrier 20 opposing thereto increases, and ‘a backward direction’ of the lens carrier 20 refers to a direction of the movement of the lens carrier 20 wherein a gap between the lower surface of the base 10 and the lower surface of the lens carrier 20 opposing thereto decreases.

If currents in one direction are applied to the coil 31 installed on the base 10, an electromagnetic force is generated between the magnet 33 and the coil 31 installed on the lens carrier 20, and the magnet 33 moves in a forward direction. Accordingly, the lens carrier 20 moves in a forward direction along an optical axis direction. As the lens carrier 20 moves in a forward direction, a gap between the bottom surface of the base 10 and the lower surface of the lens carrier 20 opposing thereto increases.

Here, the plurality of balls 41 of the main ball accommodating part 15 and the ball 42 of the sub ball accommodating part 17 support the lens carrier 20 to be slidable, and thus the lens carrier 20 may move stably. In particular, as the main ball accommodating part 15 is installed on one surface tilted with respect to one surface on which the magnet 33 and the coil 31 are installed, tilting of the lens carrier 20 by an electromagnetic force operating between the magnet 33 and the coil 31 can be minimized. Also, as the sub ball accommodating part 17 is located in a direction constituting an approximate diagonal line with the main ball accommodating part 15, tilting of the lens carrier 20 can be further reduced.

The hall sensor senses the strength of the electromagnetic force of the magnet 33 that changes according to change of the location of the magnet 33, and transmits a sensing in this regard to the controller (not shown) of the auto focusing apparatus 1. The controller of the auto focusing apparatus 1 may be included in the controller (not shown) of the portable apparatus (not shown) on which the auto focusing apparatus 1 is installed.

The controller may control the moving distance of the lens carrier 20 through a sensing signal of the hall sensor. For example, when the moving distance of the lens carder 20 is set, the controller may control the forward or backward distance by controlling the currents of the coil 31 of the driving part 30.

If the direction of the currents applied to the coil 31 is made to be a reverse direction, the lens carrier 20 may be moved in a backward direction. That is, in a backward operation of the lens carrier 20, if currents applied to the coil 31 are applied in an opposite direction to the direction of currents applied at the time of a forward operation of the lens carrier 20, an electromagnetic force in an opposite direction to a forward movement of the lens carrier 20 is generated between the coil 31 and the magnet 33, and the magnet 33 is pushed in a backward direction in an opposite way to a forward operation of the lens carrier 20. Accordingly, the lens carrier 20 moves in a backward direction.

If the lens carrier 20 moves in a backward direction, a gap between the bottom surface of the base 10 and the lower surface of the lens carrier 20 opposing thereto decreases. In this case, the lens carrier 20 is also supported to be slidable by the plurality of balls 41 accommodated in the main ball accommodating part 15 and the ball 42 accommodated in the sub ball accommodating part 17, and thus the lens carrier 20 may move in a backward direction stably.

As described above, when the lens carder 20 is moved for adjusting the focus by the auto focusing apparatus 1 according to an embodiment of the disclosure, the lens carrier 20 is guided to be slidable by the plurality of balls 41 accommodated in the main ball accommodating part 15 and the ball 42 accommodated in the sub ball accommodating part 17 installed on a different surface from the magnet 33.

As can be seen above, the plurality of balls 41, 42 installed on the base 10 support the lens carrier 20 through a point contact, and thus shaking by an external shock or various kinds of vibrations can be prevented. Also, as a different surface from the surface on which the magnet 33 is installed of the lens carrier 20 is supported by the plurality of balls 41 accommodated in the main ball accommodating part 15, and another surface of the lens carrier 20 is supported by one ball 42 accommodated in the sub ball accommodating part 17, when the lens carrier 20 is moved, tilting of the lens carrier 20 by an electromagnetic force generated between the magnet 33 and the coil 31 can be minimized or removed.

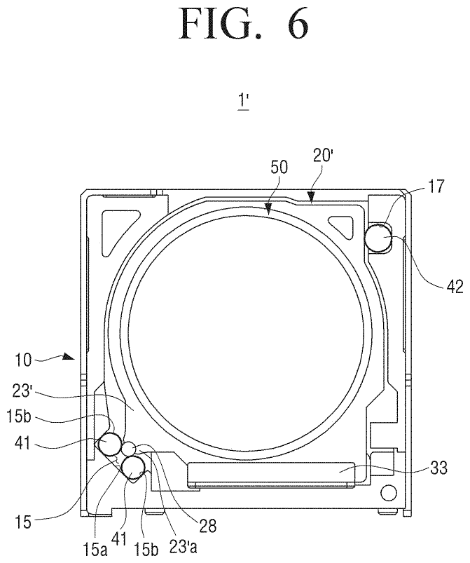

FIG. 6 is a plan view illustrating a modified embodiment of the auto focusing apparatus according to an embodiment of the disclosure. For reference, FIG. 6 illustrates a state wherein the cover has been removed.

The auto focusing apparatus 1′ illustrated in FIG. 6 is identical to the auto focusing apparatus 1 illustrated in FIG. 1 to FIG. 5 except the guide protrusion 23′ of the lens carrier 20′.

Referring to FIG. 6, on the guide protrusion 23′ of the lens carrier 20′, a guide pin 28 is provided in a location contacting the plurality of balls 41. The guide pin 28 may be formed of metal having big rigidity like iron. Accordingly, the plurality of balls 41 accommodated in the main ball accommodating part 15 support the lens carrier 20′ by contacting the guide pin 28 provided on the guide protrusion 23′. The guide pin 28 may be formed to have higher strength and smaller surface roughness compared to the guide protrusion of the lens carrier which is a conventional injection molding product.

Accordingly, as illustrated in FIG. 6, if the auto focusing apparatus 1′ is configured such that the plurality of balls 41 of the main ball accommodating part 15 are guided by the guide pin 28, in case a portable apparatus on which the auto focusing apparatus 1′ is installed falls, breakage of the guide protrusion 23′ of the lens carrier 20′ supported by the balls 41 can be prevented, and rolling resistance of the balls 41 can be reduced.

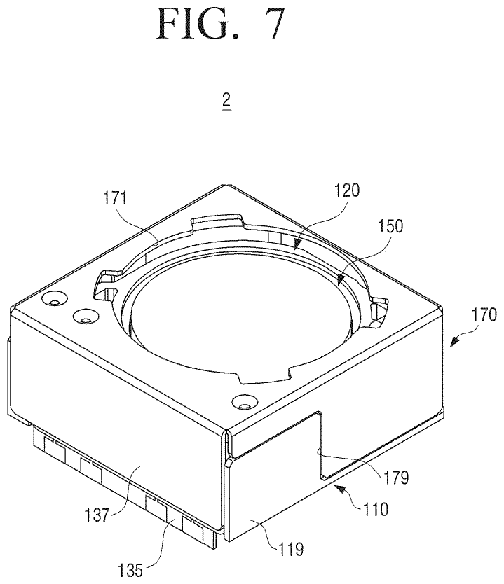

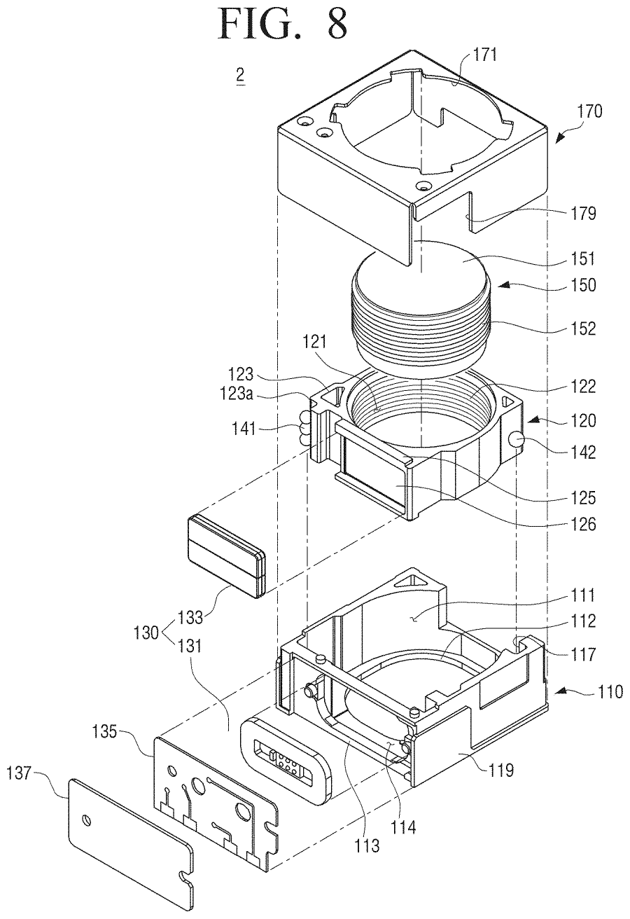

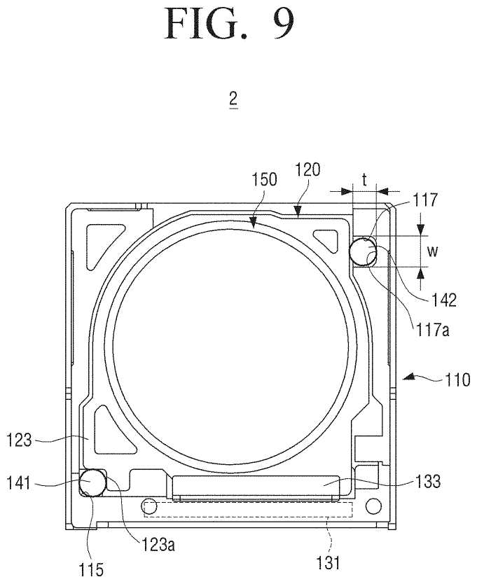

FIG. 7 is a perspective view illustrating an auto focusing apparatus according to another embodiment of the disclosure. FIG. 8 is an exploded perspective view of the auto focusing apparatus in FIG. 7. FIG. 9 is a plan view illustrating the auto focusing apparatus in FIG. 7 wherein the cover has been removed.

Referring to FIG. 7 to FIG. 9, the auto focusing apparatus 2 according to an embodiment of the disclosure may include a base 110, a lens carrier 120, a driving part 130, and a plurality of balls 141, 142.

In the center of the base 110, an accommodating grove 111 accommodating the lens carrier 120 is provided. On the bottom of the accommodating groove 111, i.e., on the lower surface of the base 110, a light passing hole 112 though which external lights pass is formed. The diameter of the light passing hole 112 is formed to be smaller than the diameter of the lens carrier 120. Accordingly, when the lens carrier 120 is inserted into the accommodating groove 111 of the base 110, the lens carrier 120 does not fall into the light passing hole 112. Also, the accommodating groove 111 is formed in a shape corresponding to the outer side surface of the lens carrier 120.

On the front surface of the base 110, a coil mounting part 113 on which the coil 131 is installed is provided. On the coil mounting part 113, an opening 114 is formed such that a magnet 133 installed on the lens carrier 120 can be exposed.

in the accommodating groove 111 of the base 110, a ball accommodating part accommodating the plurality of balls 141, 142 is provided. The ball accommodating part is provided to be connected with the accommodating groove 111. Also, the ball accommodating part may include a main ball accommodating part 115 provided on one side of the coil 131 (in other words, one side of the magnet 133) and a sub ball accommodating part 117 formed on a surface different from the inner surface of the front surface of the base 110 on which the coil 131 is installed on the other side of the coil 131.

Between the main ball accommodating part 115 and the lens carrier 120, the plurality of balls 141 are accommodated, and support the sliding movement of the lens carrier 120 in an optical axis direction. Also, between the sub ball accommodating part 117 and the lens carrier 120, one ball 142 is accommodated, and supports the sliding movement of the lens carrier 120 in an optical axis direction. Here, an optical axis direction refers to a direction that is perpendicular to the lower surface of the base 110 on which the light passing hole 112 is formed.

Referring to FIG. 9, the main ball accommodating part 115 is formed in a corner of one side of the inner surface of the base 110 facing the magnet 133 of the lens carrier 120. That is, a corner part formed by the inner surface of the front surface of the base 110 on which the coil mounting part 113 is provided and the inner side surface of the base 110 formed to be perpendicular thereto forms the main ball accommodating part 115. Here, the corner 115 wherein the inner surface of the front surface and the inner side surface of the base 110 meet is formed to have a smaller radius of curvature than the radius of the balls 141. Accordingly, the balls 141 may simultaneously contact the inner surface of the front surface and the inner side surface of the base 110.

The sub ball accommodating part 117 is formed on the inner surface of the base 110 such that it can support another surface of the lens carrier 120, i.e., a surface that is different from one surface of the lens carrier 120 on which the magnet 133 is installed or a surface of the lens carrier 120 supported by the plurality of balls 141 accommodated in the main ball accommodating part 115. In the case of the embodiment illustrated in FIG. 9, the sub ball accommodating part 117 is provided on the inner side surface of the base 110 that constitutes an approximately right angle with the front surface of the base 110 on which the coil mounting part 113 is installed, in a place that is far from the coil mounting part 111 Specifically, the sub ball accommodating part 117 is provided in an approximately diagonal direction with respect to the main ball accommodating part 115. Accordingly, the ball 142 accommodated in the sub ball accommodating part 117 may support the end portion of the lens carrier 120.

Also, the sub ball accommodating part 117 is formed such that the one ball 142 can be located in the center of the lens carrier 120 in a longitudinal direction of the lens carrier 120. That is, the lower end of the sub ball accommodating part 117 may be located in an approximate center in an approximately longitudinal direction of the base 110. Accordingly, the one ball 142 accommodated in the sub ball accommodating part 117 can support the lens carrier 120 stably.

The width w of the sub ball accommodating part 117 is formed to be bigger than the diameter of the ball 142, and the depth t of the sub ball accommodating part 117 is formed to be smaller than the diameter of the ball 142. Accordingly, the ball 142 accommodated in the sub ball accommodating part 117 may support the lens carrier 120 through a two point contact. That is, as illustrated in FIG. 9, the ball 142 accommodated in the sub ball accommodating part 117 contacts one surface of the lens carrier 120 and the bottom surface 117a of the sub ball accommodating part 117 and supports the lens carrier 120.

As the plurality of balls 141 accommodated in the main ball accommodating part 115 and the ball 142 accommodated in the sub ball accommodating part 117 constituted as described above respectively support different surfaces of the lens carrier 120, the movement of the lens carrier 120 in an optical axis direction can be supported stably.

The coil 131 is installed on the coil mounting part 113 provided on the front surface of the base 110, and one surface of the coil 131 faces the magnet 133 installed on the lens carrier 120. The coil 131 is formed by winding a wire, and is formed in an approximate track shape. The coil 131 forms the driving part 130 generating a force moving the lens carrier 120 together with the magnet 133 installed on the lens carrier 120.

On one surface of the substrate 135, a terminal part (not shown) that is installed on the outer side of the coil 131, and applies power to the coil 131 may be provided. Through this, the coil 131 may receive power from the substrate 135 and generate a driving power moving the lens carrier 120 by an interaction with the magnet 133. As an example, the substrate 135 may be a flexible printed circuit board (FPCB), and the coil 131 may he electronically connected with the substrate 135 and fixed at the same time.

The yoke 137 may be arranged on the outer side of the coil 131, and fixed to the outer surface of the base 110. The yoke 137 may be formed to have a larger area than the area of the coil 131, and through this, the strength of a magnetic field formed between the coil 131 and the magnet 133 may be increased, and at the same time, the magnetic field may be extended.

Meanwhile, on the substrate 135, a hall sensor (not shown) may be mounted. The hall sensor may be spaced apart from the outer circumferential surface of the magnet 133 in an adjacent distance and may be electronically connected with the substrate 135. The controller (not shown) of the auto focusing apparatus 2 may sense the location of the lens carrier 120 (or the location of the lens) through the hall sensor, and may calculate a direction and a moving distance by which the lens carrier 120 is to be moved in an auto focusing operation based on the location information of the lens sensed through the hall sensor.

The lens carrier 120 may include a hollow 121 corresponding to the light passing hole 112 formed on the base 110, and its outer surface may he formed in a shape corresponding to the accommodating groove 111 formed on the base 110. On the outer surface of the lens carrier 120, a guide protrusion 123 is provided. The guide protrusion 123 may protrude in a location corresponding to the main ball accommodating part 115 of the base 110, and the front end 123a of the guide protrusion 123 may be formed to block the front side of the main ball accommodating part 115 of the base 110.

Referring to FIG. 9, the guide protrusion 123 may be located to be eccentric to one side from the center of one surface of the lens carrier 120. That is, the guide protrusion 123 is formed to protrude toward the corner part 115, i.e., the main bail accommodating part of the base 110. The front end 123a of the guide protrusion 123 is formed as an approximately inversed L-shaped groove, and is formed to block the front side of the main ball accommodating part 115 of the base 110. Accordingly, a space wherein the plurality of balls 141 are accommodated is formed by the main ball accommodating part 115 and the front end 123a of the guide protrusion 123.

The plurality of balls 141 are installed in a row between the guide protrusion 123 and the main ball accommodating part 115. In the case of this embodiment, three balls 141 are laminated in a row between the guide protrusion 123 and the main ball accommodating part 115 as illustrated in FIG. 8.

Here, the plurality of balls 141 accommodated in the main ball accommodating part 115 support the lens carrier 120 through a four point contact. Specifically, one ball 141 contacts both side surfaces of the inversed L-shaped groove of the guide protrusion 123 of the lens carrier 120 and the inner surface of the front surface of the base 110 and the inner side surface of the base 110, and thus the ball 141 may support the lens carrier 120 through a four point contact.

If the plurality of balls 141 accommodated in the main ball accommodating part 115 contact the guide pin 128 of the guide protrusion 123 of the lens carrier 120 and support one side of the lens carrier 120 in an X-Y direction, the other side of the lens carrier 120 may be tilted in a Y direction due to the influence of an electromagnetic force between the magnet 133 and the coil 131. Here, the ball 142 inserted into the sub ball accommodating part 117 may support the other surface of the lens carrier 120 just by a two point contact, and may thereby minimize tilting of the lens carrier 120.

On one surface of the lens carrier 120, a magnet mounting part 125 on which the magnet 133 is installed may be provided. For example, the magnet mounting part 125 may be located on a surface different from the guide protrusion 123, and may protrude from one surface of the lens carrier 120. Accordingly, the guide protrusion 123 is formed to protrude from a surface tilted with respect to one surface of the lens carrier 120 on which the magnet mounting part 125 is installed. By this, the lens carrier 120 may receive a force in a tilted direction by the plurality of balls 141 accommodated in the main ball accommodating part 115. Also, on the magnet mounting part 125, an installing groove 126 on which the magnet 133 is installed may be formed,

The magnet 133 may magnetize a plurality of poles such that polarity is intersected. For example, in the magnet 133, an N pole and an S pole may respectively be magnetized on the inner/outer circumferential surfaces on one side and the other side. That is, on one side of the surface of the magnet 133 facing the coil 131, an N pole may be magnetized, and an S pole may be magnetized on the other side, respectively, and on the opposing surface, an S pole may be magnetized on one side, and an N pole may be magnetized on the other side, respectively.

As described above, by magnetizing an N pole and an S pole as four poles respectively on the inner/outer circumferential surfaces on both sides of the magnet 133, a magnetic field section wherein the strength of the magnetic force sensed by the hall sensor increases or decreases uniformly may be formed.

To the hollow 121 of the lens carrier 120, the lens barrel 150 may be coupled. For example, on the inner circumferential surface of the hollow 121 of the lens carrier 120, a female screw 122 may be formed, and on the outer circumferential surface of the lens barrel 150, a male screw 152 may be formed, and the lens barrel 150 may be screw-coupled to the lens carrier 120. Accordingly, it is possible to separate the lens barrel 150 from the lens carrier 120 even after coupling the lens barrel 150 to the lens carrier 120.

In the auto focusing apparatus 2 according to an embodiment of the disclosure having a configuration as described above, by the configuration wherein the guide protrusion 123 of the lens carrier 120 is supported by the plurality of balls 141 accommodated in the main ball accommodating part 115 of the base 110, and one surface of the lens carrier 120 different from the surface on which the guide protrusion 123 is installed is supported by one ball 142 accommodated in the sub ball accommodating part 117 of the base 110, the lens carrier 120 may be driven according to a predetermined route without shaking along an optical axis direction. Also, in the case of the auto focusing apparatus 2 according to this embodiment, a guide pin 128 having big strength is arranged on the part supported by the plurality of balls 141 accommodated in the main ball accommodation part 115. Accordingly, there is an advantage that the number of the balls 141 supporting the lens carrier 120 can be reduced.

Also, the cover 170 may be coupled to the base 110 so as to cover the side surfaces and the top surface of the base 110. On the top surface of the cover 170, a light passing hole 171 through which external lights pass is provided. The cover 170 is provided so as to shield an external electromagnetic influence. For example, for the cover 170, materials such as steel, stainless, nickel-silver, etc. which are advantageous in shielding electromagnetic waves may be used. The cover 170 may be formed to correspond to the shape and the size of the base 110.

For preventing mis-coupling of the cover 170 to the base 110, a coupling part may be provided on the cover 170 and the base 110. For example, on one side surface of the base 110, a coupling surface 119 protruding to a specific height may be provided, and on one side surface of the cover 170, a coupling groove 179 corresponding to the coupling surface 119 of the base 110 may be provided. Accordingly, if the coupling groove 179 of the cover 170 is inserted into the coupling surface 119 of the base 110, the cover 170 may be coupled to the base 110 easily and precisely.

Hereinafter, an operation of an auto focusing apparatus according to an embodiment of the disclosure having a configuration as above will be described with reference to FIG. 7 to FIG. 9.

If currents in one direction are applied to the coil 131 installed on the base 110, an electromagnetic force is generated between the magnet 133 and the coil 131 installed on the lens carrier 120, and the magnet 133 moves in a forward direction. Accordingly, the lens carrier 120 moves in a forward direction along an optical axis direction. As the lens carrier 120 moves in a forward direction, a gap between the bottom surface of the base 110 and the lower surface of the lens carrier 120 opposing thereto increases.

Here, the plurality of balls 141 of the main ball accommodating part 115 and the bail 142 of the sub ball accommodating part 117 support the lens carrier 120 to be slida.ble, and thus the lens carrier 120 may move stably. In particular, as the main ball accommodating part 115 is installed in a corner of the base 110 that is separated farthest from one surface on which the magnet 133 and the coil 131 are installed, tilting of the lens carrier 120 by an electromagnetic force operating between the magnet 133 and the coil 131 can be minimized. Also, as the sub ball accommodating part 117 is located in a direction constituting an approximate diagonal line with the main ball accommodating part 115, tilting of the lens carrier 120 can be further reduced.

The hall sensor senses the strength of the electromagnetic force of the magnet 133 that changes according to change of the location of the magnet 133, and transmits a sensing signal in this regard to the controller (not shown) of the auto focusing apparatus 2. The controller of the auto focusing apparatus 2 may be included in the controller (not shown) of the portable apparatus (not shown) on which the auto focusing apparatus 2 is installed.

The controller may control the moving distance of the lens carrier 120 through a sensing signal of the hall sensor. For example, when the moving distance of the lens carrier 120 is set, the controller may control the forward or backward distance by controlling the currents of the coil 131 of the driving part 130.

if the direction of the currents applied to the coil 131 is made to be a reverse direction, the lens carrier 120 may be moved in a backward direction. That is, in a backward operation of the lens carrier 120, if currents applied to the coil 131 are applied in an opposite direction to the direction of currents applied at the time of a forward operation of the lens carrier 120, an electromagnetic force in an opposite direction to a forward movement of the lens carrier 120 is generated between the coil 131 and the magnet 133, and the magnet 133 is pushed in a backward direction in an opposite way to a forward operation of the lens carrier 120. Accordingly, the lens carrier 120 moves in a backward direction.

If the lens carrier 120 moves in a backward direction, a gap between the bottom surface of the base 110 and the lower surface of the lens carrier 120 opposing thereto decreases. In this case, the lens carrier 120 is also supported to be slidable by the plurality of balls 141 accommodated in the main ball accommodating part 115 and the ball 142 accommodated in the sub ball accommodating part 117, and thus the lens carrier 120 may move in a backward direction stably.

So far, a case wherein the lens carrier 120 is supported by the plurality of balls 141, 142 accommodated in the main ball accommodating part 115 and the sub ball accommodating part 117 arranged in a diagonal line was described, but the location of the sub ball accommodating part 117 is not limited thereto. The sub ball accommodating part 117 may be formed in any location on the inner side surface of the base 110 which is approximately perpendicular to one surface on which the magnet mounting part 125 of the lens carrier 120 is installed.

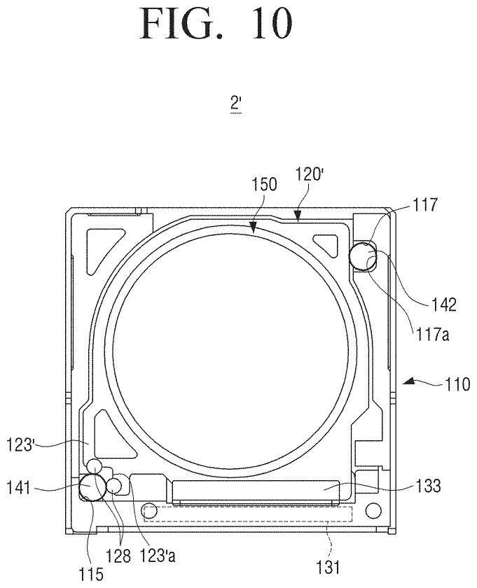

FIG. 10 is a plan view illustrating a modified embodiment of the auto focusing apparatus according to another embodiment of the disclosure.

The auto focusing apparatus 2′ illustrated in FIG. 10 is identical to the auto focusing apparatus 2 illustrated in FIG. 7 to FIG. 9 except the guide protrusion 123′ of the lens carrier 120′.

Referring to FIG. 10, on the front end 123′a of the guide protrusion 123′ of the lens carrier 120′, two guide pins 128 are provided in locations contacting the plurality of balls 141, i.e., on both side surfaces of the inversed L-shaped groove. The guide pins 128 may be installed such that some parts of them protrude on the side surfaces of the inversed L-shaped groove of the front end 123a of the guide protrusion so as to have a point contact with each of the plurality of balls 141 accommodated in the main ball accommodating part 115. The guide pins 128 may be formed of metal having big rigidity like iron. Accordingly, the plurality of balls 141 accommodated in the main ball accommodating part 115 support the lens carrier 120′ by contacting the two guide pins 128 provided on the guide protrusion 123′. The guide pins 128 may be formed to have higher strength and smaller surface roughness compared to the guide protrusion of the lens carrier which is a conventional injection molding product.

Accordingly, as illustrated in FIG. 10, if the auto focusing apparatus 2′ is configured such that the plurality of balls 141 of the main ball accommodating part 115 are guided by the two guide pins 128, in case a portable apparatus on which the auto focusing apparatus 2′ is installed falls, breakage of the guide protrusion 123′ of the lens carrier 120′ supported by the balls 141 can be prevented, and rolling resistance of the balls 141 can be reduced.

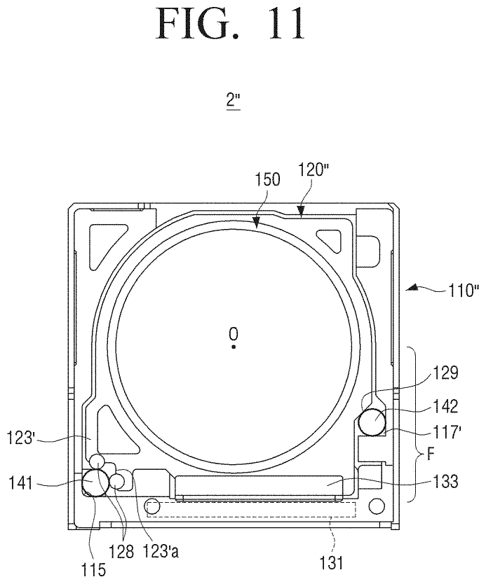

FIG. 11 is a plan view illustrating another modified embodiment of the auto focusing apparatus according to another embodiment of the disclosure.

Referring to FIG. 11, the auto focusing apparatus 2″ according to another embodiment of the disclosure may include a base 110″, a lens carrier 120″, a driving; part 130, and a plurality of balls 141, 142.

The base 110″ and the lens carrier 120″ are mostly identical to the base 110 and the lens carrier 120′ of the auto focusing apparatus 2′ illustrated in FIG. 10, but the location of the sub ball accommodating part 117′ is different. Accordingly, hereinafter, only the location of the sub ball accommodating part 117′ will be described.

Referring to FIG. 11, the sub ball accommodating part 117′ is installed to be adjacent to the magnet 133 on the inner side surface that is approximately perpendicular to the inner surface of the front surface of the base 110″ on which the coil 131 is installed. For example, the sub ball accommodating part 117′ may be installed to support the approximate center of the side surface of the front part F of the lens carrier 120″. Here, the front part F of the lens carrier 120″ refers to an area from the center of the lens carrier 120″ to the magnet mounting part 125.

The sub ball accommodating part 117′ is formed in an approximate L-shape, and is formed to contact the ball 142 on two points. Also, the sub ball accommodating part 117′ is formed such that the one ball 142 can be located in the center of the lens carrier 120″ in a longitudinal direction of the lens carrier 120″. Accordingly, the one ball 142 accommodated in the sub ball accommodating part 117′ may support the lens carrier 120″ stably.

The part of the lens carrier 120″ supported by the ball 142 accommodated in the sub ball accommodating part 117′ is formed as a tilted surface 129 that is tilted with respect to the magnet mounting surface 125. Accordingly, the ball 142 accommodated in the sub ball accommodating part 117′ may support the lens carrier 120″ through a three point contact. That is, the ball 142 of the sub ball accommodating part 117′ may support the lens carrier 120″ by having point contacts with the tilted surface 129 of the lens carrier 120″ and the two surfaces of the sub ball accommodating part 117′ of the base 110″.

According to the auto focusing apparatus according to an embodiment of the disclosure as described above, by a configuration wherein the guide protrusion of the lens carrier is supported by the plurality of balls accommodated in the main ball accommodating part, and one surface of the lens carrier different from the surface on which the guide protrusion is installed is supported by one ball accommodated in the sub ball accommodating part of the base, the lens carrier may be driven according to a predetermined route without shaking along an optical axis direction. Accordingly, the auto focusing apparatus according to an embodiment of the disclosure may perform movements of the lens carrier on which a lens holder is installed precisely and stably, and thus it may perform a precise and stable auto focusing function.

Also, in the case of the auto focusing apparatus according to an embodiment of the disclosure, a guide pin having big strength is arranged on the part supported by the plurality of balls accommodated in the main ball accommodation part. Accordingly, there are advantages that the number of balls supporting the lens carrier can be reduced, and reliability can be improved.

In the above description, the disclosure was explained with reference to exemplary embodiments. However, it should be noted that the terms used herein are for explaining the disclosure, and the terms are not to be interpreted to limit the disclosure. Also, various amendments and modifications of the disclosure may be made based on the above description. Accordingly, the disclosure may be implemented freely within the scope of the appended claims, unless there is no additional mention in that regard.

### INDUSTRIAL APPLICABILITY

The disclosure relates to an auto focusing apparatus that is capable of photographing a clear image by adjusting a focal distance.

What is claimed is:

1. An auto focusing apparatus comprising:
a base having an accommodation groove;
a lens carrier provided in the accommodation groove of the base;
a magnet provided on one surface of the lens carrier;
a coil provided to the base so as to face the magnet;
a main ball accommodation part formed in a corner of one side of the inner surface of the base facing the magnet on the lens carrier;
a sub-ball accommodation part which is provided on the inner surface of the base, on which the main ball accommodation part is not formed, and which supports the other surface of the lens carrier, on which the magnet is not provided;
a guide protrusion which is provided on the lens carrier at one side of the magnet and which protrudes toward the main ball accommodation part; and
a plurality of balls provided between the main ball accommodation part and the guide protrusion and between the sub-ball accommodation part and the other surface of the lens carrier,
wherein one ball is provided between the sub-ball accommodation part and the other surface of the lens carrier.

2. The auto focusing apparatus of claim 1,
wherein the main ball accommodation part is formed as a groove having a rectangular cross section, and the bottom surface of the main ball accommodation part is formed to be tilted with respect to one surface of the base on which the coil is provided.

3. The auto focusing apparatus of claim 2,
wherein the front end of the guide protrusion is formed in a round shape, and
the plurality of balls are provided to the main ball accommodation part in two rows in an optical axis direction centered around the front end of the guide protrusion.

4. The auto focusing apparatus of claim 3,
wherein a guide pin is provided on the part of the guide protrusion contacted by the plurality^{,} of balls.

5. The auto focusing apparatus of claim 1,
wherein the front end of the guide protrusion is formed as an inversed L-shaped groove, and
the plurality of balls are provided between the front end of the guide protrusion and the main ball accommodation part in a row.

6. The auto focusing apparatus of claim 5,
wherein guide pins are provided on both side surfaces of the inversed L-shaped groove of the front end of the guide protrusion so as to have a point contact with each of the plurality of balls.

7. The auto focusing apparatus of claim 1,
wherein the sub-ball accommodation part is formed such that the balls support the center of the lens carrier in the longitudinal direction of the lens carrier.

8. The auto focusing apparatus of claim 1,
wherein the balls accommodated in the main ball accommodation part support the lens carrier in an X-Y direction, and
the balls accommodated in the sub-ball accommodation part support the lens carrier in a Y direction.
